(19) United States
(12) Patent Application Publication
(10) Pub. No.: US 2006/0041369 A1
(43) Pub. Date: Feb. 23, 2006

(54) METHOD OF CONTROLLING THE SUPERCHARGE IN A COMBUSTION ENGINE AND VEHICLE HAVING A SUPERCHARGED COMBUSTION ENGINE WITH ELECTRONIC CONTROL MEMBERS FOR CONTROLLING THE SUPERCHARGE

(75) Inventors: Sixten BERGLUND, Torslanda (SE); Anders ERIKSSON, Goteborg (SE); Marcus STEEN, Angered (SE); Soren UDD, Nodinge (SE)

Correspondence Address: NOVAK DRUCE & QUIGG, LLP, 1300 EYE STREET NW, 400 EAST TOWER, WASHINGTON, DC, 20005, US

(73) Assignee: VOLVO LASTVAGNAR AB, Goteborg (SE)

(21) Appl. No.: 11/163,593

(22) Filed: Oct. 24, 2005

Related U.S. Application Data
(63) Continuation of application No. PCT/SE04/00400, filed on Mar. 18, 2004.

(30) Foreign Application Priority Data
Apr. 24, 2003 (SE) 0301198-8

(51) Int. Cl. G06F 19/00

(52) U.S. Cl. 701/100; 701/101

(57) ABSTRACT

A vehicle having a combustion engine supercharged by a turbocharger (6) with variable turbine geometry and having electronic control members (3) controlling the supply of fuel and air to the combustion chamber of the engine. The control members are designed, during forward travel of the vehicle, on the basis of input information on at least road gradient and gas pedal position, to estimate future road resistance and the time period up to a future transient in the operating condition of the engine. The control members are designed to control changes in the turbine geometry during the time period so as to optimize the response of the engine when the transient arises.

### CROSS-REFERENCE TO RELATED APPLICATIONS

The present application is a continuation patent application of International Application No. PCT/SE2004/000400 filed 18 Mar. 2004 which was published in English pursuant to Article 21(2) of the Patent Cooperation Treaty, and which claims priority to Swedish Application No. 03011 98-8 filed 24 Apr. 2003. Said applications are expressly incorporated herein by reference in their entireties.

### TECHNICAL FIELD

The present invention relates to a method, in a supercharged combustion engine in a vehicle, during forward travel of the vehicle, of regulating geometric changes in the supercharge system of the engine which promote changes in the boost pressure of the engine.

The invention also relates to a vehicle having a supercharged combustion engine with electronic control members controlling the supply of fuel and air to the combustion chamber of the engine.

### BACKGROUND OF THE INVENTION

In previously known supercharge systems for combustion engines, geometric changes in the systems, which promote changes in the boost pressure of the engine and/or exhaust-gas back pressure, are regulated instantaneously and internally within the engine, i.e. only after a change in the operating condition of the engine has been initiated. This leads to delays in the regulation owing to the time constants for emptying or pressurizing the pipe system of the engine, which can be large in volume. It is generally known, for example, that with present-day regulation it is not possible to avoid a so-called “turbo lag” in a turbocharged engine, i.e. a certain delay from the driver giving gas to the pick-up in torque. When a gearshift is made in an automatic gearbox to an engine having a turbo compressor, in which the boost pressure is regulated by regulating the exhaust-gas flow to the turbine with the aid of a shunt valve, a so-called “waste gate” valve, this valve is opened for a fall-off in torque based on engine-internal control independent of information on transients (for example gearshift) in the drive train. Typically, it is opened when the boost pressure exceeds a predetermined threshold value and is closed when the boost pressure falls below another predetermined threshold value. An early opening has a positive effect upon fuel consumption, whilst an early closing has a positive effect upon the response of the engine. A timely adjustment of the boost pressure in advance of a transient also has a positive effect upon the engine compression braking performed when an upward gearshift is made.

### SUMMARY OF THE INVENTION

An object of the present invention is to produce a method of controlling geometric changes in the supercharge system of the engine, for example of controlling a waste-gate valve, so that changes in the boost pressure of the engine can be matched in advance to a future course of events, instead of, as in the current situation, only being controlled instantaneously internally within the engine.

This is achieved according to the invention by calculating the future road resistance of the vehicle, by estimating the time period to a future transient in the operating condition of the engine and by making, during this time period, necessary geometric changes in the supercharge system of the engine so as to optimize at least the response of the engine when the transient arises.

When a gearshift is made, a better response than previously can thereby be achieved, for example, by closing the waste-gate valve before the boost pressure has had time to fall (or the gearshift is wholly completed), so that the boost pressure has time to be built up to the necessary level to provide immediate response, upon a subsequent pick-up in torque, as soon as the gearshift operation is concluded.

The invention is based on the fact that electronic control members controlling said geometric changes, for example re-setting of a waste-gate valve, have information on when a future transient, for example gearshift, will take place. This information is founded on information on future changes in the road resistance of the vehicle. The invention is herein based upon the technique described in patent application SE 01 03629-2. With inputted parameters and hence knowledge of at least road gradient and vehicle gas pedal position, but also possibly covering engine, turbo and transmission characteristics, the control members are here designed to elect when a future gearshift will be made according to a chosen gearshift strategy. Information on future road resistance can herein be obtained by the use of GPS equipment and electronic maps containing stored data on the topography of the surroundings. For a more detailed description of the technique for identifying the surroundings of the vehicle, reference is therefore made to the abovementioned patent application.

A motor vehicle of the type stated in the introduction is characterized according to the invention in that the control members are designed, during forward travel of the vehicle, on the basis of input information on at least road gradient and gas pedal controls position, to estimate future road resistance and the time period to a future transient in the operating condition of the engine and to control geometric changes in the supercharge system of the engine during said time period so as to optimize the response of the engine when the transient arises.

### BRIEF DESCRIPTION OF THE DRAWINGS

The invention is described in greater detail below with reference to illustrative embodiments shown in the appended drawing, in which:

FIG. 1a shows a diagrammatic representation of a combustion engine and transmission with a first embodiment of a turbo compressor;

FIG. 1b shows a second and FIG. 1c shows a third embodiment of a turbo compressor for the engine in FIG. 1a; and

FIG. 2 is a chart representing a simulation of forward travel of an including vehicle.

### DETAILED DESCRIPTION

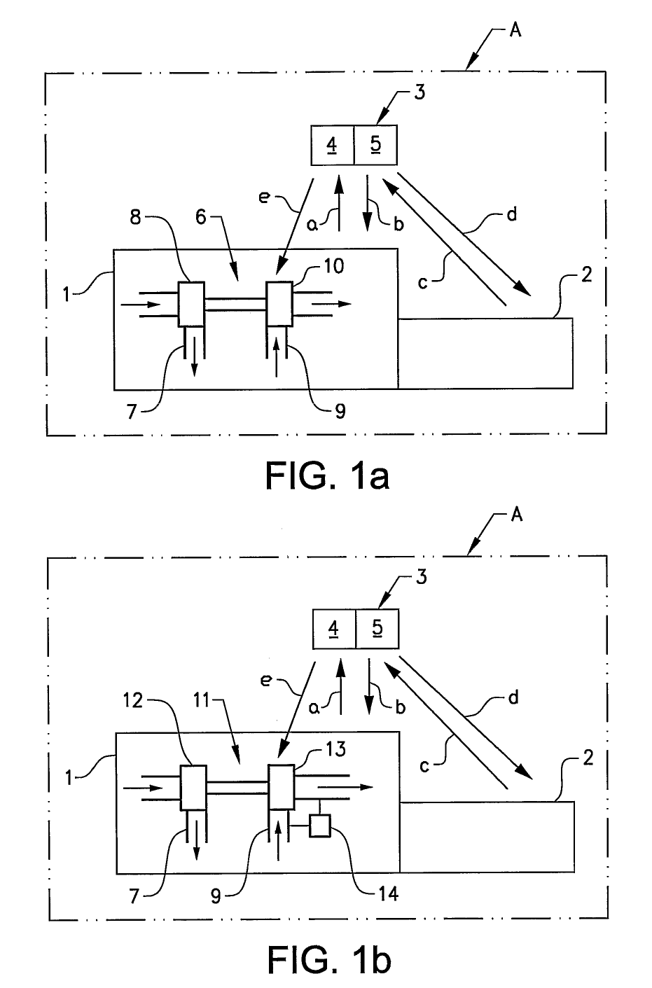

In FIG. 1a, 1 denotes a combustion engine in a motor vehicle A, to which a transmission 2 is drive-coupled. The engine 1 and the transmission 2 are controlled by an electronic control unit 3 comprising an engine control part 4 and a transmission control part 5, which communicate with each other. The control can be realized according to the model described in the abovementioned SE 01 03629-2 and symbolized respectively by the arrows “a” and “b” for the engine control and by “c” and “d” for the transmission control.

In FIG. 1a, a turbocharger is denoted in general terms by 6, which turbocharger comprises a compressor 8 communicating with the induction line 7 of the engine and a turbine 10 communicating with the exhaust-gas line 9 of the engine, which turbine can be a turbine with variable blade geometry, a so-called VGN (Variable Geometry Turbine), by means of which the boost pressure delivered by the compressor 8 is regulated. The control unit 3 controls the geometry of guide rails in the turbine, symbolized by the arrow “e”. As an alternative to the turbocharger 6, a turbocharger 11, shown in FIG. 1b, can be used. The turbocharger 11 consists of a compressor 12 and a turbine 13, which communicate respectively with the induction line 7 and exhaust-gas line 9 of the engine. Here, the boost pressure is regulated with the aid of a shunt valve 14, a so-called waste-gate valve, which leads the exhaust gases past the turbine when the boost pressure has reached a predetermined level. The waste-gate valve 14 is controlled by the control unit 3. As a further alternative to the turbocharger 6 or 11, a turbocharger 15, shown in FIG. 1c, can be used. It consists of a compressor 16 and a so-called VNT (Variable Nozzle Turbine), which is a turbine 17 with variable throttle valve 18 on the inlet side of the turbine. The valve 18 is controlled by the control unit 3 for regulating the boost pressure of the compressor 16.

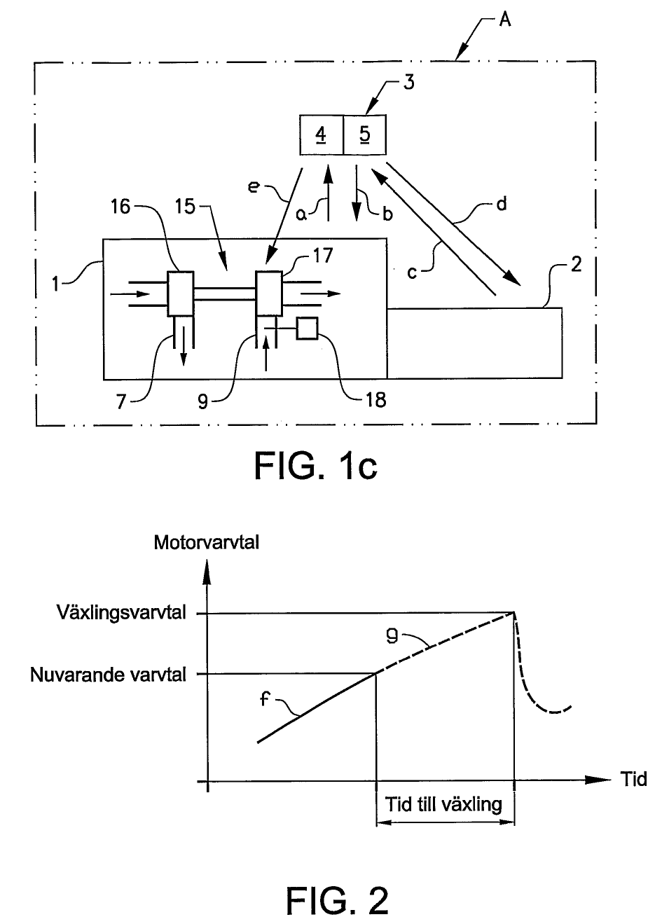

In the control unit 3, the forward travel of the vehicle is stored in the form of the increase in engine speed as a function of time, which in FIG. 2 is marked by the continuous curve “f”. With information on gas pedal position and information from, for example, GPS equipment with electronic maps containing inlaid topography, future road resistance and the time period from a particular rev speed to a rev speed at which the next gearshift in the transmission is estimated to occur, which in FIG. 2 is marked by a dashed extension “g” of the curve “f”, can be simulated. For a more detailed description of how the forward travel of the vehicle can be simulated in model-based fashion, reference should be made to the abovementioned SE 01 03629-2.

Within the time period marked in FIG. 2, the control unit 3 regulates the boost pressure, so that necessary pressure change is effected when the gearshift is initiated. Prior to the conclusion of the gearshift operation, the control unit makes necessary preparations for a subsequent pick-up in torque, so that optimal response is obtained in connection with the pick-up. By optimal response it is meant that a change in engine torque requested by the driver of the vehicle, a fall-off in torque and a pick-up in torque-occurs with the least possible delay, i.e. response means, in simple terms, rapid torque build-up in both the positive (driving) and negative (braking) direction. “Economy situation” in subsequent patent claims means that the fuel economy is the most dominant control unit, i.e. the driver is prepared to forego other characteristics for the benefit of economy, while “performance situation” means that drive power performance is the most dominant control parameter, i.e. the driver is ready to forego other characteristics in order to deliver power and torque to the vehicle.

If the engine is provided with a compression brake device, for example of the type shown and described in EP 0 458 857 B1, to which reference is made for a more detailed description of the design and functioning of a type of compression brake, the boost pressure is controlled during the time period, as an upward gearshift is made in the gearbox, in order to optimize the engine braking torque.

What is claimed is:

1. A method, in a supercharged combustion engine in a vehicle, during forward travel of the vehicle, of regulating geometric changes in the supercharge system of the engine which promote changes in the boost pressure of the engine, wherein the future road resistance of the vehicle is calculated and the time period to a future transient in the operating condition of the engine (1) is estimated and necessary geometric changes in the supercharge system (6,11,15) of the engine are affected during this time period to optimize the response of the engine when the transient arises.

2. The method as recited in claim 1, wherein when a future transient implying a fall-off in torque occurs, geometric changes are made which result in a lowering of the boost pressure during the time period, and in that, conversely, when a future transient implying a pick-up in torque occurs, geometric changes are made which result in a raising of the boost pressure during the time period.

3. The method as recited in claim 2 further comprising regulating the boost pressure in connection with gearshifting in an automatic transmission (2) coupled to the engine (1), and, relative to a gearshift in an economy situation, geometric changes are made which result in a lowering of the boost pressure prior to the initiation of the gearshift operation.

4. The method as recited in claim 2 further comprising regulating the boost pressure in connection with gearshifting in an automatic transmission (2) coupled to the engine (1), and, relative to a gearshift in a performance situation, geometric changes are made which result in a raising of the boost pressure prior to the conclusion of the gearshift operation.

5. The method as recited in claim 4 for regulating the boost pressure in connection with engine braking in a vehicle having an engine with compression braking, wherein when the engine is braked in connection with an upward gearshift in a performance situation, geometric changes are made during the time period prior to the initiation of the gearshift operation thereby optimizing the engine braking torque during the upward gearshift.

6. The method as recited in claim 3 for regulating the boost pressure in connection with engine braking in a vehicle having an engine with compression brake, wherein when the engine is braked in connection with an upward gearshift in an economy situation, geometric changes are made during said time period prior to the initiation of the gearshift operation thereby optimizing the engine braking torque during the upward gearshift.

7. A vehicle having a supercharged combustion engine (1) with electronic control members (3) controlling the supply of fuel and air to the combustion chamber of the engine, wherein the control members (3) are designed, during forward travel of the vehicle, on the basis of input information on at least road gradient and gas pedal position, to estimate future road resistance and the time period to a future transient in the operating condition of the engine and to control geometric changes in the supercharge system (6,11,15) of the engine during the time period thereby optimizing the response of the engine when the transient arises.

8. The vehicle as recited in claim 7, wherein the supercharge system further comprises a turbocharger (11) having a shunt valve (14) for regulating the quantity of exhaust gas supplied to the turbine (13) of the compressor and the control members (3) are configured to control the shunt valve.

9. The vehicle as recited in claim 7, wherein the supercharge system further comprises a turbocharger (6) having a turbine with variable geometry and the control members (3) are configured to control the turbine geometry.

10. The vehicle as recited in claim 7, wherein the supercharge system comprises a turbocharger (15) having a turbine (17) with a variable throttle valve (18) on the inlet side of the turbine and in that the control members (3) are designed to control the throttle valve.

11. The vehicle as recited in 7, further comprising an automatic transmission (2) coupled to the engine (1) and wherein the control members (3) have an engine and transmission control function configured to estimate the time period to a future gearshift and to control the geometric changes in the supercharge system (6,11,15) so that the boost pressure is actively changed prior to the initiation of the gearshift.

12. The vehicle as recited in 8, further comprising an automatic transmission (2) coupled to the engine (1) and wherein the control members (3) have an engine and transmission control function configured to estimate the time period to a future gearshift and to control the geometric changes in the supercharge system (6,11,15) so that the boost pressure is actively changed prior to the initiation of the gearshift.

13. The vehicle as recited in 9, further comprising an automatic transmission (2) coupled to the engine (1) and wherein the control members (3) have an engine and transmission control function configured to estimate the time period to a future gearshift and to control the geometric changes in the supercharge system (6,11,15) so that the boost pressure is actively changed prior to the initiation of the gearshift.

14. The vehicle as recited in 10, further comprising an automatic transmission (2) coupled to the engine (1) and wherein the control members (3) have an engine and transmission control function configured to estimate the time period to a future gearshift and to control the geometric changes in the supercharge system (6,11,15) so that the boost pressure is actively changed prior to the initiation of the gearshift.
